(19) United States
(12) Patent Application Publication
(10) Pub. No.: US 2019/0104288 A1
(43) Pub. Date: Apr. 4, 2019

(54) THREE-DIMENSIONAL PRINTING SYSTEM AND FABRICATION METHOD THEREOF

(71) Applicant: Young Optics Inc., Hsinchu City (TW)

(72) Inventors: Ming-Fu HSU, Hsinchu City (TW); Chao-Shun CHEN, Hsinchu City (TW); Chang-Chun CHEN, Hsinchu City (TW)

(21) Appl. No.: 15/846,894

(22) Filed: Dec. 19, 2017

(30) Foreign Application Priority Data
Sep. 29, 2017 (TW) 106133690

(51) Int. Cl. H04N 9/31; B29C 64/393; B33Y 10/00; B33Y 30/00; B33Y 50/02; B29C 64/282

(52) U.S. Cl. CPC H04N 9/3185; H04N 9/3147; B29C 64/393; B29C 64/282; B33Y 30/00; B33Y 50/02; B33Y 10/00

(57) ABSTRACT

One embodiment of the invention provides a three-dimensional printing system includes a first projector, a second projector, and a solidification region. The solidification region accommodates a curable material and has a first area and a second area. The first projector projects a first image on the first area, the second projector projects a second image on the second area, and the first image and the second image are stitched together to form an image seam. The image seam is the only one overlapping area between the first image and the second image, and a width of the image seam is smaller than a span of five consecutive pixels arranged crossing the image seam.

### BACKGROUND OF THE INVENTION

### a. Field of the Invention

The invention relates to a three-dimensional (3D) printing system and a fabrication method of the 3D printing system.

### b. Description of the Related Art

Projection images are liable to distort due to abbreviations of optical lenses and assembly tolerances of a system. Therefore, an image to be projected needs to be calibrated or corrected in advance to precisely control dimensions of a projection image. In that case, a calibrated or corrected projection image engaging in 3D printing work may meet high accuracy requirements for 3D printing. Further, in a 3D printing task, several projection images from respective projectors may be stitched together to increase effective printing areas. However, abbreviations of optical lenses and assembly tolerances of a system may make such image blending more difficult. A conventional method is to superpose different images, correct them for distortion, and blending overlapped image portions to uniform brightness. This method, however, is time consuming, hard to improve stitching accuracy, and liable to blur images in the overlapped area to thus difficult to meet high quality and high speed requirements for 3D printing.

The information disclosed in this “BACKGROUND OF THE INVENTION” section is only for enhancement understanding of the background of the described technology, and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### BRIEF SUMMARY OF THE INVENTION

The invention provides a three-dimensional (3D) printing system and a fabrication method of the 3D printing system.

Other objects and advantages of the invention may be further illustrated by the technical features broadly embodied and described as follows.

In order to achieve one or a portion of or all of the objects or other objects, one aspect of the invention provides a three-dimensional printing system including a first projector, a second projector; and a solidification region. The solidification region accommodates a curable material and has a first area and a second area. The first projector projects a first image on the first area, the second projector projects a second image on the second area, and the first image and the second image are stitched together to form an image seam. The image seam is the only one overlapping area between the first image and the second image, and a width of the image seam is smaller than a span of five consecutive pixels arranged crossing the image seam.

Another aspect of the invention provides a fabrication method of a three-dimensional printing system. The method includes the steps of: providing a casing; providing a first projector and placing the first projector inside the casing; providing a second projector and placing the second projector inside the casing; projecting a first image by the first projector to a first area of a solidification region; and projecting a second image by the second projector to a second area of the solidification region. The first image and the second image are stitched together to form an image seam, the image seam is the only one overlapping area between the first image and the second image, and a width of the image seam is smaller than a span of five consecutive pixels arranged crossing the image seam.

Another aspect of the invention provides a fabrication method of a three-dimensional printing system. The method includes the steps of: providing a plurality of calibration patterns and a plurality of projection images of the calibration patterns, where each two adjacent calibration patterns form a pattern seam and each of the projection images overlaps a neighboring pattern seam; and detecting positional deviation between each of the calibration pattern and a projection image corresponding to the calibration pattern to generate at least one position calibration file.

According to the above aspects, projection images having been corrected for distortion are automatically fitted at an image seam having a very small width without forming extra overlapping areas. Under the circumstance, conventional complicated processes that adjust brightness of a large overlapping area of a stitched image are no longer needed to simplify computing architecture, shorten processing time of image blending, increase projection speed for stitched images, and reduce costs. Besides, in a 3D printing task, position calibration files can be retrieved from a storage device to facilitate automatic calibration processing and thus reduce fabrication costs. Further, the calibrated stitched image may achieve large image dimensions, high accuracy and high speeds in 3D printing work.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a 3D printing system according to an embodiment of the invention.

FIG. 2A shows a calibrated stitched image projected by different projectors according to an embodiment of the invention.

FIG. 2B shows the scope of a seam in a stitched image according to an embodiment of the invention.

FIG. 3A and FIG. 3B show schematic diagrams illustrating generation of a position calibration file according to an embodiment of the invention.

FIG. 4 shows a schematic diagram illustrating positional deviation between projected intersections and printed intersections according to an embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

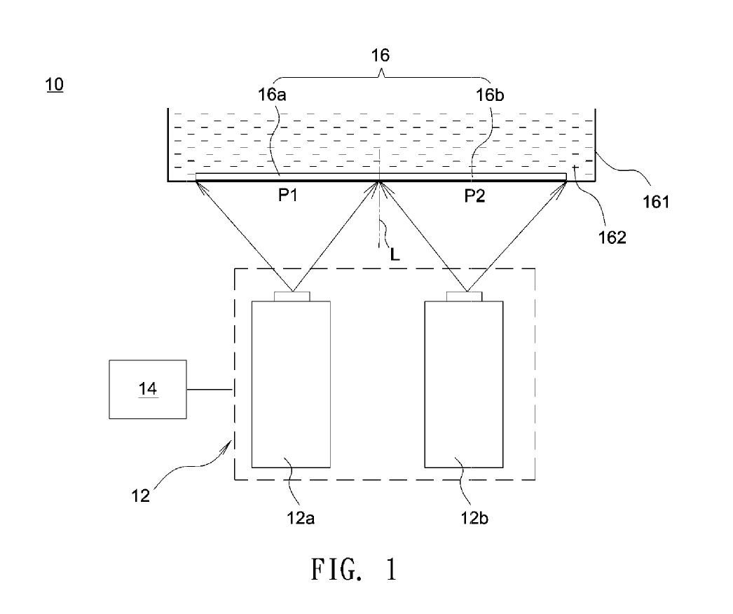

FIG. 1 shows a schematic diagram of a three-dimensional (3D) printing system according to an embodiment of the invention. As shown in FIG. 1, a 3D printing system 10 includes multiple projectors 12 (such as a first projector 12a and a second projector 12b), a solidification region 16 and multiple position calibration files (not shown) corresponding to multiple projectors 12. The solidification region 16 may be, for example, disposed with a curing tank 161 to accommodate a curable material 162, and the solidification region 16 has a first area 16a and a second area 16b. The first position calibration file may calibrate a first raw image to be projected to form a first image P1 projected by the first projector 12a. The second position calibration file may calibrate a second raw image to be projected to form a second image P2 projected by the second projector 12b. The first projector 12a may project the first image P1 on the first area 16, and the second projector 12b may project the second image P2 on the second area 16b. Further, in one embodiment, a processor 14 may generate slice files of a 3D object to be printed by cutting thin pieces from a solid model of the 3D object. The processor 14 may use the first and second position calibration files to correct each raw image to be projected and output the first image P1 and the second image P2 to the projectors 12a and 12b, respectively, to allow the projectors 12a and 12b to project a stitched image P by fitting together the first image P1 and the second image P2. Therefore, the first image P1 and the second image P2 closely connected at an image seam L are entirely projected on the curable material 162 to cure the curable material 162 layer by layer. In this embodiment, multiple projectors 12 are disposed under the solidification region 16 and project images P1 and P2 upward onto the solidification region 16, but the invention is not limited thereto. In other embodiment, multiple projectors 12 may be disposed above the solidification region 16 and project images P1 and P2 downward onto the solidification region 16.

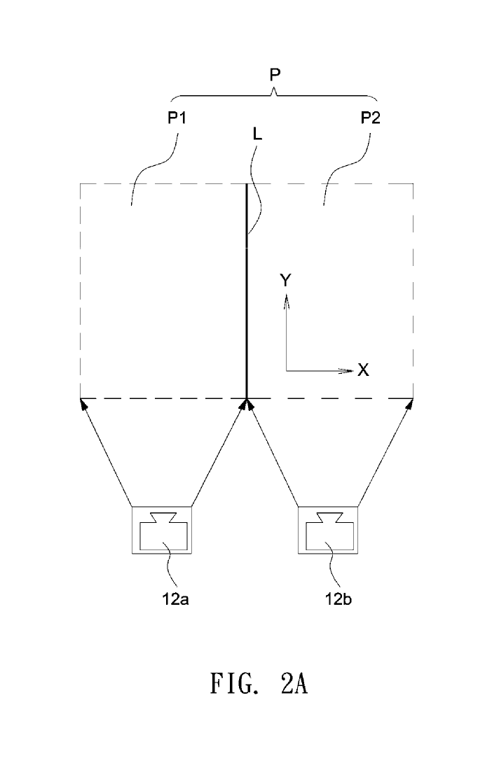

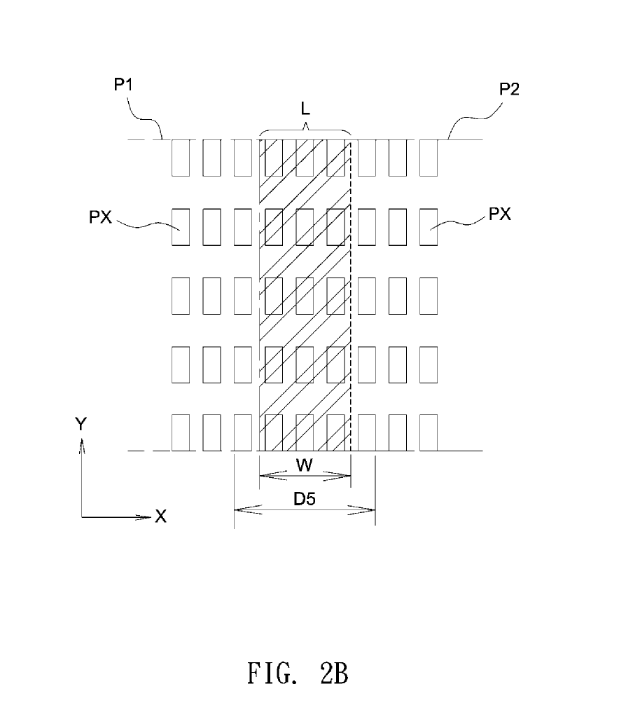

As shown in FIG. 2A, since the stitched image P has been corrected for distortion according to the position calibration files, the first image P1 and the second image P2 are stitched together to form an image seam L, and the image seam L is the only one overlapping area between the first image P1 and the second image P2. Therefore, the first image P1 the second image P2 are well fitted without forming an extra overlapping area as shown in conventional designs where a width of the extra overlapping area along a horizontal direction X may range from dozens to hundreds of pixels. In this embodiment, the first image P1 and the second image P2 are arranged in the horizontal direction X and fitted together, and the image seam L extends in a vertical direction Y. As shown in FIG. 2B, the first image P1 and the second image P2 may include multiple pixels PX, and, in this embodiment, a width W of the image seam L (a length along the horizontal direction X) is smaller than a span D5 of five consecutive pixels PX. Herein, the span D5 is a distance between two ends of five consecutive pixels PX that are arranged along the horizontal direction X and crossing the image seam L. Further, in this embodiment, an extension direction of the image seam (vertical direction Y) is substantially perpendicular to an arrangement direction of the five consecutive pixels (horizontal direction X), but the invention is not limited there to. In other embodiment, a width W of the image seam L may be smaller than a span of three consecutive pixels PX.

According to the above embodiments, because a stitched image projected by multiple projectors is already corrected by each position calibration file, the projectors may project images with precise dimensions having been corrected for distortion, and two adjacent images are closely fitted together at an image seam having a very small width (smaller than a span of five consecutive pixels). Under the circumstance, conventional complicated processes that adjust brightness of a large overlapping area of stitched images are no longer needed to shorten processing time of image blending and reducing costs. Besides, by stitching images from different projectors, a stitched image may include different kinds of patterns or a single large pattern to be printed out on a curable layer, therefore increasing effective printing areas.

Note the projectors and the projection images to be stitched are not limited to a specific number, as long as two adjacent projection images are overlapped only at a seam having a width smaller than a span of five consecutive pixels. Beside, the processor 14 is not limited to a specific type or an architecture, and may be, for example, a CPU, a field programmable gate array (FPGA) or a graphics processing unit (GPU).

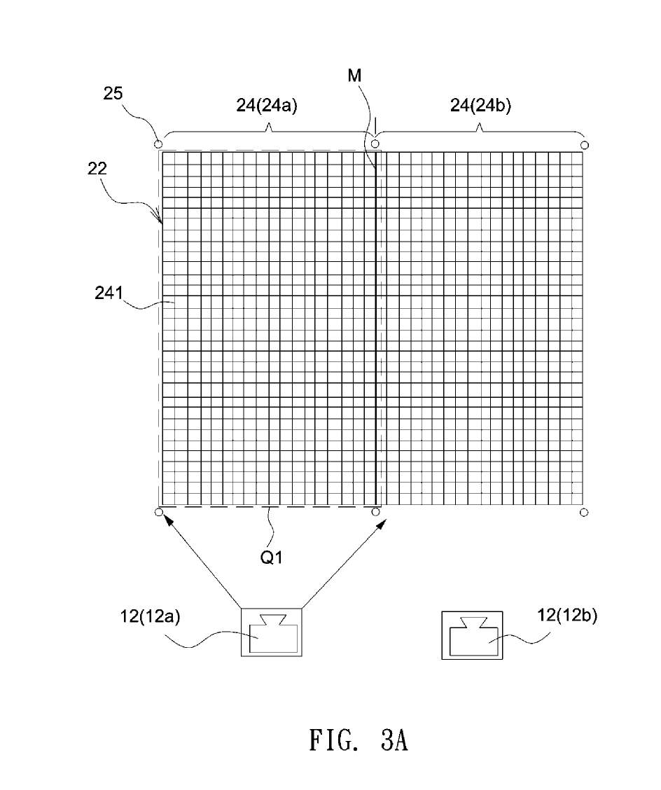

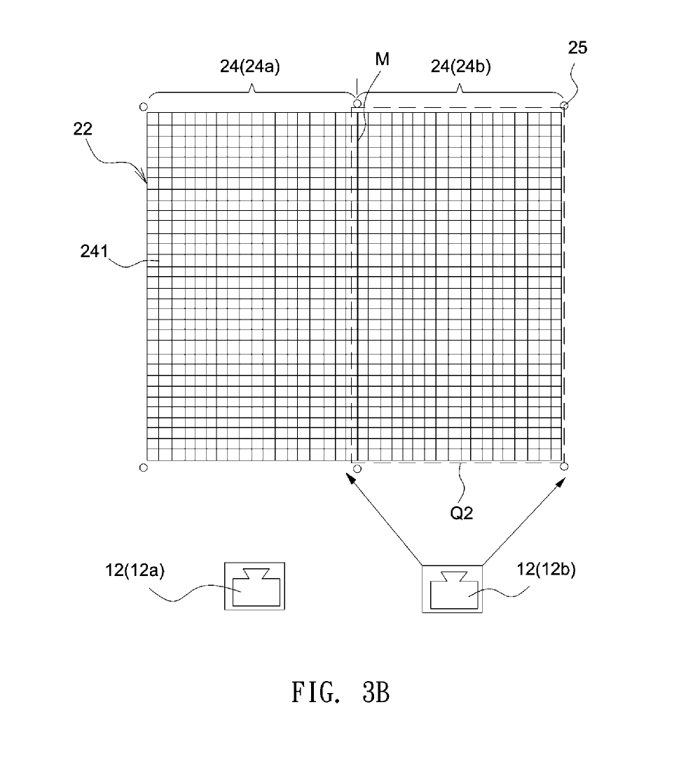

In one embodiment, a calibration pattern and its projection image may be used, through detection of positional deviation between the calibration pattern and the corresponding projection image, to generate a position calibration file. FIG. 3A and FIG. 3B show schematic diagrams illustrating generation of a position calibration file according to an embodiment of the invention. In this embodiment, a calibration plane 22 and a plurality of calibration patterns 24 (such as calibration patterns 24a and 24b) are used to generate a position calibration file. The calibration patterns 24 may be disposed on the calibration plane 22, but the invention is not limited thereto. In one embodiment, the calibration pattern 24 may include multiple printed grid lines 241 crossing each other, and each of the projectors 12 may take turns to project an image of a calibration pattern 24 on the calibration plane 22 to generate a position calibration file. For example, the projectors 12a and 12b are first placed inside a casing of a 3D printing device and then respectively calibrated. As shown in FIG. 3A, the projector 12a projects a calibration pattern 24a on a predetermined position delimited by positioning points 25 on the calibration plane 22 to form a projection image Q1. The projection image Q1 is compared with the corresponding calibration pattern 24a for positional deviation to generate a first position calibration file. Then, turning to the projector 12b shown in FIG. 3B, the projector 12b projects a calibration pattern 24b on a predetermined position delimited by positioning points 25 on the calibration plane 22 to form a projection image Q2. The projection image Q2 is compared with the corresponding calibration pattern 24b for positional deviation to generate a second position calibration file. Through the calibration realized according to the first and the second position calibration files, each projected grid line is aligned with each printed grid line in any image projected by the projectors 12a and 12b, and thus the boundaries of the projection image Q1 and the projection image Q2 may automatically coincide with the pattern seam M. Under the circumstance, in a 3D printing task where the projectors 12a and 12b project a stitched image P corrected by position calibration files, the two adjacent images P1 and P2 are automatically fitted at an image seam L having a very small width. In this embodiment, the use of a calibration plane 22 may resolve the problem of a limited depth of field to simplify calibration processes and enhance accuracy, but the invention is not limited thereto. In other embodiment, a position calibration file can be generated without the use of the calibration plane 22.

In one embodiment shown in FIGS. 3A and 3B, each of the projection image Q1 and the projection image Q2 may overlap a neighboring pattern seam M (i.e., the pattern seam is located inside a dashed rectangle representing the scope of a projection image) to facilitate the alignment of projected grid lines and printed grid lines. Further, the projection images Q1 and Q2 calibrated by position calibration files may be compared to the calibration patterns 24a and 24b again to generate updated position calibration files, and the projection images are repeatedly calibrated according to updated position calibration files until the positional deviation is corrected to lower than a preset value. This may allow for more accurate distortion correction and precise stitched boundary.

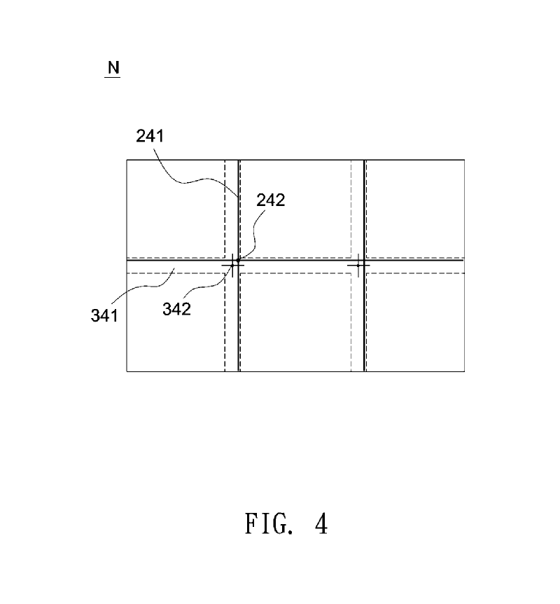

FIG. 4 shows a partial enlarged diagram N of FIG. 3A. In one embodiment shown in FIG. 4, multiple printed grid lines 241 crossing each other may form multiple printed intersections 242, and projected grid lines 341 of each projection image cross each other to form a plurality of projected intersections 342. Each printed intersection 242 may serve as a reference grid for calibration. Therefore, the differences in the coordinate values of the projected intersections 342 and the printed intersections 242 can be detected to generate position calibration files and assess the accuracy of calibration.

Moreover, generating position calibration files can be realized by various devices or systems. For example, a projector may project a calibration pattern on a calibration plane, such as a diffuser, to form a projection image, and the projection image may be reflected by a reflection mirror to be captured by an image-pickup device. The image-pickup device may capture calibration patterns formed by printed grid lines and projection image of the printed grid lines, and the captured images are transmitted to a processor. The processor may recognize positioning points for positioning and positional differences between printed grid lines and project grid lines, and uses the information of positional differences to generate a position calibration file. The position calibration files may be stored in a storage device such as a 3D printer, a computer or a cloud storage device. In a 3D printing task, the processor may retrieve corresponding position calibration files from a storage device, correct a stitched image corresponding to a slice file according to position calibration files, and project a calibrated image to obtain precise stitching and printing output.

According to the above embodiments, projection images having been corrected for distortion are automatically fitted at an image seam having a very small width without forming extra overlapping areas. Under the circumstance, conventional complicated processes that adjust brightness of a large overlapping area of a stitched image are no longer needed to simplify computing architecture, shorten processing time of image blending, increase projection speed for stitched images, and reduce costs. Besides, in a 3D printing task, position calibration files can be retrieved from a storage device to facilitate automatic calibration processing and thus reduce fabrication costs. Further, the calibrated stitched image may achieve large image dimensions, high accuracy and high speeds in 3D printing work.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A three-dimensional printing system, comprising:
a first projector;
a second projector; and
a solidification region for accommodating a curable material and having a first area and a second area, the first projector projecting a first image on the first area, the second projector projecting a second image on the second area, the first image and the second image being stitched together to form an image seam, the image seam being the only one overlapping area between the first image and the second image, and a width of the image seam being smaller than a span of five consecutive pixels arranged crossing the image seam.

2. The three-dimensional printing system as claimed in claim 1, wherein an extension direction of the image seam is substantially perpendicular to an arrangement direction of the five consecutive pixels.

3. The three-dimensional printing system as claimed in claim 1, further comprising:
a processor for calibrating a first raw image to be projected to form the first image and output the first image to the first projector, and calibrating a second raw image to be projected to form the second image and output the second image to the second projector.

4. The three-dimensional printing system as claimed in claim 3, wherein the processor is a CPU, a field programmable gate array (FPGA) or a graphics processing unit (GPU).

5. The three-dimensional printing system as claimed in claim 1, further comprising:
a first position calibration file for calibrating a first raw image to be projected to form the first image; and
a second position calibration file for calibrating a second raw image to be projected to form the second image.

6. The three-dimensional printing system as claimed in claim 5, wherein an extension direction of the image seam is substantially perpendicular to an arrangement direction of the five consecutive pixels.

7. The three-dimensional printing system as claimed in claim 5, further comprising:
a processor for calibrating the first raw image to be projected according to the first position calibration file to form the first image and output the first image to the first projector, and calibrating the second raw image to be projected according to the second position calibration file to form the second image and output the second image to the second projector.

8. The three-dimensional printing system as claimed in claim 7, wherein the processor is a CPU, a field programmable gate array (FPGA) or a graphics processing unit (GPU).

9. The three-dimensional printing system as claimed in claim 5, wherein each of the first position calibration file and the second position calibration file is obtained by detecting positional deviation between a calibration pattern and a projection image of the calibration pattern.

10. The three-dimensional printing system as claimed in claim 9, wherein the calibration pattern is disposed on a calibration plane, and the projection image of the calibration pattern is projected on the calibration plane.

11. The three-dimensional printing system as claimed in claim 9, wherein the calibration pattern includes a plurality of printed intersections of printed grid lines, each of the projection images includes a plurality of projected intersections, and the position calibration file is generated by detecting differences in the coordinate values of the projected intersections and the printed intersections.

12. A fabrication method of a three-dimensional printing system, comprising:
providing a casing;
providing a first projector and placing the first projector inside the casing;
providing a second projector and placing the second projector inside the casing;
projecting a first image by the first projector to a first area of a solidification region; and
projecting a second image by the second projector to a second area of the solidification region, the first image and the second image being stitched together to form an image seam, the image seam being the only one overlapping area between the first image and the second image, and a width of the image seam being smaller than a span of five consecutive pixels arranged crossing the image seam.

13. The fabrication method as claimed in claim 12, further comprising:
using a first position calibration file to calibrate a first raw image to be projected to form the first image;
using a second position calibration file to calibrate a second raw image to be projected to form the second image; and
respectively transmitting the first image and the second image to the first projector and the second projector.

14. The fabrication method as claimed in claim 13, further comprising:
detecting positional deviation between a first calibration pattern and a projection image of the first calibration pattern to form the first position calibration file; and
detecting positional deviation between a second calibration pattern and a projection image of the second calibration pattern to form the second position calibration file.

15. The fabrication method as claimed in claim 14, wherein the calibration patterns are disposed on a calibration plane, and the projection images of the calibration patterns are projected on the calibration plane.

16. The fabrication method as claimed in claim 12, wherein an extension direction of the image seam is substantially perpendicular to an arrangement direction of the five consecutive pixels.

17. A fabrication method of a three-dimensional printing system, comprising:
providing a plurality of calibration patterns and a plurality of projection images of the calibration patterns, wherein each two adjacent calibration patterns form a pattern seam, and each of the projection images overlaps a neighboring pattern seam; and
detecting positional deviation between each of the calibration patterns and a projection image corresponding to the calibration pattern to generate at least one position calibration file.

18. The fabrication method as claimed in claim 17, wherein the calibration patterns are disposed on a calibration plane, and the projection images of the calibration patterns are projected on the calibration plane.

19. The fabrication method as claimed in claim 17, wherein each of the calibration patterns includes a plurality of printed intersections of printed grid lines, each of the projection images includes a plurality of projected intersections, and the position calibration file is generated by detecting differences in the coordinate values of the projected intersections and the printed intersections.

20. The fabrication method as claimed in claim 17, wherein the projection images of the calibration patterns are projected by a plurality of projectors, and the plurality of projectors take turns to project the projection images.
